(19) United States
(12) Patent Application Publication
(10) Pub. No.: US 2022/0219026 A1
(43) Pub. Date: Jul. 14, 2022

(54) PM PERSONAL MASK

(71) Applicant: Jan WISNIEWSKI, Warsaw (PL)

(72) Inventor: Jan WISNIEWSKI, Warsaw (PL)

(21) Appl. No.: 17/614,350

(22) PCT Filed: May 26, 2020
(86) PCT No.: PCT/PL2020/000049

§ 371 Date: Nov. 25, 2021

(30) Foreign Application Priority Data
May 26, 2019 (PL) P.430042

(51) Int. Cl. A62B 23/02; A62B 18/08

(52) U.S. Cl. CPC A62B 23/025; A62B 18/08

(57) ABSTRACT

Dust-resistant mask equipped with a thermoelectric generator attached to the body. The mask is capable of powering an LED, battery or external devices. On the inside of the mask body, there may be a condensation system, grooves for collecting moisture, and a hole for drainage. The mask may have filters of a mechanical, biological and chemical type, both as part of its body and on the inside of the mask body.

The subject-matter of the invention is a personal dust-resistant mask, in particular as an urban mask, an anti-dust mask or an anti-dust and anti-microbial mask, anti-smog mask.

Known solutions of this type usually consist of a piece of cloth or plastic formed in such a way as to cover the mouth and nose and a single- or multi-stage filtration system.

U.S. Pat. No. 4,141,703A relates to a polymer dust-resistant mask equipped with a multi-stage filter.

Patent No. CA2337434 relates to a mask with an exhaust valve to make exhalation easier.

Patent No. WO2004100762 (A2) relates to a system monitoring the chemical composition of exhaled air, equipped with a sensor and a cooling system that condenses moisture below the dew point and collects it into a container in which the above-mentioned sensor is located.

Utility model No. CN208096075 relates to a mask equipped with a heat exchanger in the form of a multilayer flow channel inside a mask body.

The application No. RU2578808 relates to a dermal cosmetic mask which does not protect the respiratory system and which is equipped with thermocouples used during cosmetic procedures.

Among the known masks without anti-dust properties there is a solution that allows the user to change the temperature of the face skin as part of cosmetic procedures. Among the solutions whose construction closest resemble the subject-matter of the invention is a system monitoring the chemical composition of exhaled air, equipped with a sensor and a cooling system that condenses moisture below the dew point and collects it into a container in which the above-mentioned sensor is located. The starting point for most modern dust-resistant masks is a mask equipped with a single- or multi-layer filter. A well-known and beneficial solution that can be used in masks, including those that perform an additional function, is to include a valve that facilitates exhalation and reduces fogging of the mask.

The purpose of this solution is to enable the use of the temperature difference between the inside of the mask and the cooler outside air to generate electricity, and to supply the lighting element which allows to obtain an independent, hands-free light source when using a respiratory mask which may also perform additional, more advanced functions regarding respiratory protection.

The solution according to the invention is a dust-resistant mask equipped with at least one thermoelectric generator, preferably made of PEDOT:PSS, attached to the mask body. An additional beneficial effect can be achieved when the thermoelectric generator is equipped with a power supply system which may include a power source, preferably in form of one or more batteries, and power cables as well as a power controller. It is desirable that there be a moisture condensation system on the inside of the thermoelectric generator. Additional beneficial effects can be achieved if the moisture condensation system is equipped with grooves, preferably sloping downwards towards half the width of the thermoelectric generator. It is desirable if one or more of the grooves narrow towards half the width of the thermoelectric generator. An additional beneficial effect can be achieved if at least part of the inner surface of the thermoelectric generator is hydrophobic, preferably superhydrophobic. An additional beneficial effect can be achieved in the variant equipped with at least one filter on the inside of the mask housing—preferably with replaceable filter or filters. Additional beneficial effects can be achieved when at least some of the filters in the mask equipment meet EPA standards, preferably HEPA13. Additional beneficial effects can be achieved when at least some of the filters in the mask are biologically reactive, preferably made from bamboo, soybean or coconut fiber or activated carbon. Additional beneficial effects may be achieved when one or more of the filters in the mask equipment are chemical filters. It is expedient when a radiator is attached to the outer surface of the thermoelectric generator. An improved drainage of moisture can be achieved when, relative to the vertically oriented mask, an outward deflection angle of the upper edge of the thermoelectric generator from its lower edge is 3 to 50 degrees, preferably 5 to 30 degrees, and most preferably 5 to 15 degrees. Additional advantages can be achieved when the thermoelectric generator has, in its lower part, at least one opening to the outside of the mask body, preferably sloping downwards, preferably narrowing towards the outside of the mask body. An additional beneficial effect can be achieved when the radiator is equipped with ribs that protrude from the thermoelectric generator in a non-uniform manner, especially protruding from the thermoelectric generator in a non-uniform manner, expediently in a non-uniform manner along its length. Additional benefits are achievable in the variant where the mask body has, at its edges, at least one gasket, preferably porous, which may have grooves for a substance that alleviates skin inflammation, preferably containing aloe extract, may have a substance on its surface that alleviates skin inflammation, preferably containing aloe extract and which may have, in its pores, a substance that alleviates inflammation of the skin, preferably containing aloe extract. Additional benefits in powering the thermoelectric generator and removing moisture are achieved when the thermoelectric generator has whiskers on its inside, partially or completely extending laterally beyond the edges of the thermoelectric generator. Additional advantages are achieved when the mask is equipped with an illumination element, especially in the form of a electroluminescent diode.

The mask body is understood as the main body of the mask, which may be partially air-permeable, including a filter for solid particles or one to which such a filter is attached.

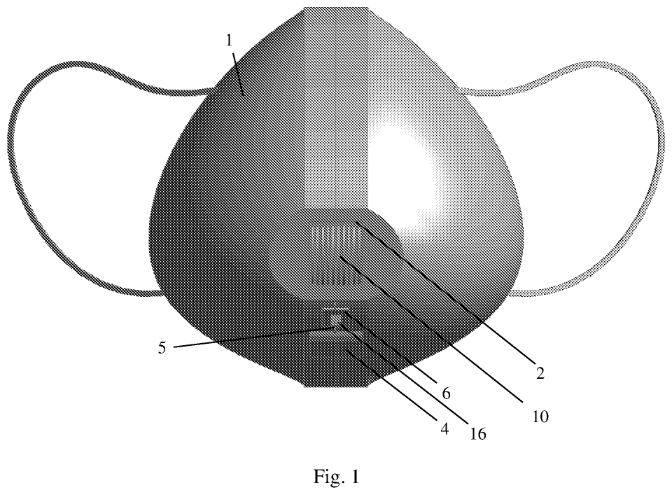

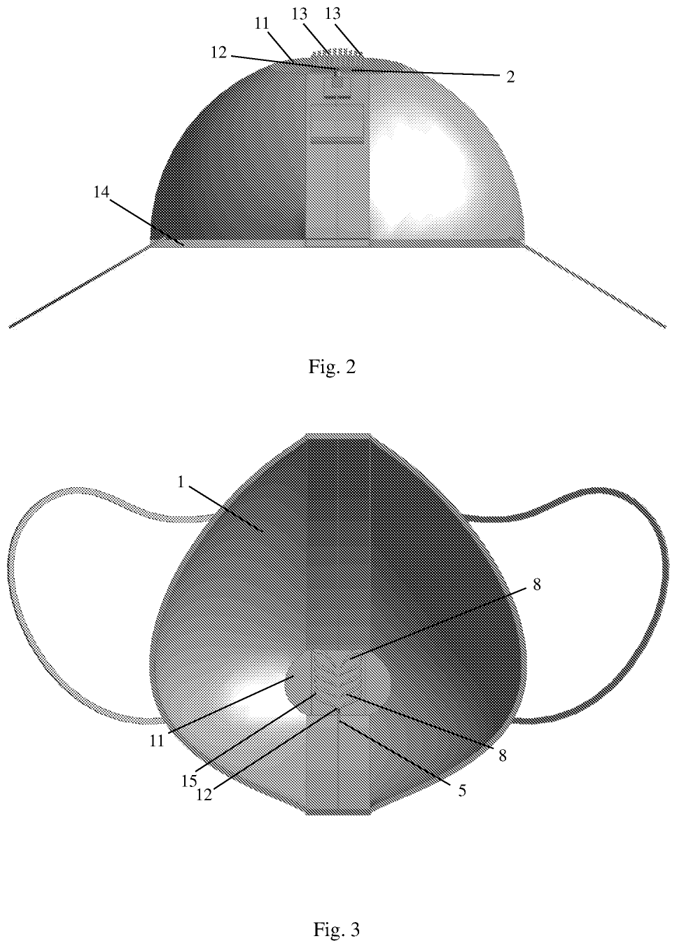

The mask is shown in an exemplary embodiment, where FIG. 1 shows a dust-resistant mask equipped with a thermoelectric generator in a front view, FIG. 2 is the mask from FIG. 1. in a bottom view, and FIG. 3 shows the cross-section of the mask from FIG. 1 in a rear view.

As shown in FIG. 1, the mask in its embodiment has a thermoelectric generator 2 attached to the mask body 1, positioned at ten degrees to the vertically oriented mask, equipped with the power supply 3 including the battery power source 4, power cables 5 and controller 6. On the inner side of the thermoelectric generator 2 there is a moisture condensing system 7 equipped with grooves 8 inclined downwards towards half the width of the thermoelectric generator 2. The radiator 10 is attached to the outer surface of the thermoelectric generator 2, and the power supply system 3 is equipped with a charging socket of the external elements 11. The thermoelectric generator has, in its lower part, one opening 12 leading outside of the mask body 1, sloping downwards, narrowing towards the outside of the mask body 1. The radiator 10 has ribs 13 protruding from the thermoelectric generator 2 in a non-uniform manner both along its length and relative to each other. The mask body 1 has, at its edges, a gasket 14 with a porous structure. The thermoelectric generator 2 has, on its inner side, whiskers 15 which partially extend laterally beyond the edges of the thermoelectric generator 2. A lighting element 16 in the form of an LED is connected to the power supply 3.

The operation of the object according to the invention makes it possible to generate electricity by wearing the mask in an environment with an ambient temperature much lower than the temperature of the exhaled air, and to use it to charge the electric battery, transfer energy to other devices or modules, or to directly or indirectly power the lighting element, especially in form of an energy-saving LED. In addition, it allows to mitigate skin conditions from long-term wearing of masks that tightly adhere to the skin surface. The use of filters that meet EPA and HEPA standards allows to reduce the effects of dust. The use of biologically reactive filters reduces the harmful effects of bioaerosols, including fungal, bacterial and viral ones. The use of one or more chemical filters allows for the chemical removal of many types of substances, e.g. volatile organic compounds. If at least part of the inner surface of the thermoelectric generator is hydrophobic, preferably superhydrophobic, better detachment, aggregation and dripping down of droplets is achieved. Depending on e.g. the projected generation capacity, it may be necessary to select such a radiator, i.e. a heat exchanger, which allows increased efficiency of heat exchange on the outer side of the mask. When the radiator has ribs protruding from the thermoelectric generator in a non-uniform manner with respect to each other, deliberately non-uniformly along its length, it is possible to reduce the inhibition of the flow through the radiator with a boundary layer and accelerate the heat transfer, increasing the efficiency of the radiator. Adding a porous gasket can achieve the planned airtightness with less pressure on the skin, thus reducing irritation with prolonged use. The use of whiskers protruding beyond the surface of the thermoelectric generator may allow for more efficient generation of electricity due to a greater heat exchange surface inside the mask. Getting rid of moisture when using the dust-resistant mask, in particular as an anti-smog mask, may have a positive effect on the body's immunity, reducing the tendency to fall ill, limiting the loss of the beneficial oral microflora, and preventing fungal infections deep inside the oral cavity. The generator does not touch the skin, so it does not cause local cooling of the epithelium, and thanks to forced convection it achieves higher efficiency. A source of lighting and energy that uses the waste heat emitted during exhalation can, in some situations, prove essential for survival, ensuring safe travelling and finding shelter.

1. A dust-resistant mask, characterized in that attached to the mask body (1) is a thermoelectric generator (2), preferably made of PEDOT:PSS.

2. The mask of claim 1, characterized in that the mask is equipped with a power supply system (3).

3. The mask of claim 1 or 2, characterized in that the supply system (3) has a power supply (4), preferably in the form of one or more batteries or accumulators, and power supply cables (5).

4. The mask of claim 2 or 3, characterized in that the supply system (3) has a supply controller (6).

5. The mask of claim 1, 2, 3 or 4, characterized in that on the inside of the thermoelectric generator (2) there is a moisture condensation system (7).

6. The mask of claim 1, 2, 3, 4 or 5, characterized in that the moisture condensation system (7) has grooves (8), preferably inclined downwards towards half the width of the thermoelectric generator (2).

7. The mask of claim 6, characterized in that one or more grooves (8) narrow towards half the width of the thermoelectric generator (2).

8. The mask of claim 1, 2, 3, 4, 5, 6 or 7, characterized in that at least part of the inner surface of the thermoelectric generator (2) is hydrophobic, preferably superhydrophobic.

9. The mask of claim 6 or 7, characterized in that the surface of the grooves (8) is hydrophobic, preferably superhydrophobic.

10. The mask of claim 1, 2, 3, 4, 5, 6, 7, 8, or 9, characterized in that the mask body (1) is provided with at least one filter (9), on the inside, preferably a replaceable one.

11. The mask of claim 10, characterized in that at least some of the filters (9) meet EPA standard, preferably HEPA13.

12. The mask of claim 10 or 11, characterized in that at least some of the filters (9) are biologically reactive, preferably made from soybean, coconut, bamboo or activated carbon.

13. The mask of claim 10, 11 or 12, characterized in that the one or more filters (9) are chemical filters.

14. The mask of claim 1, 2, 3, 4, 5, 6, 7, 8, 9, 10, 11, 12, or 13, characterized in that a radiator (10) is attached to the outer surface of the thermoelectric generator (2).

15. The mask of claim 2, 3, 4, 5, 6, 7, 8, 9, 10, 11, 12, 13, or 14, characterized in that the supply system (3) has a connector for charging external elements (11), preferably a lightning, micro-USB or USB-C connector.

16. The mask of claim 1, 2, 3, 4, 5, 6, 7, 8, 9, 10, 11, 12, 13, 14 or 15, characterized in that, for a vertically positioned mask, the angle of inclination towards the outside of the upper the edge of the thermoelectric generator (2) from its lower edge is from 3 to 50 degrees, preferably from 5 to 30 degrees, most preferably from 5 to 15 degrees.

17. The mask of claim 1, 2, 3, 4, 5, 6, 7, 8, 9, 10, 11, 12, 13, 14, 15, or 16, characterized in that the thermoelectric generator (2) has, in its lower part, at least one opening (12) leading outwardly of the mask body (1), preferably inclined downward, preferably narrowing towards the outside of the mask body (1).

18. The mask of claim 14, 15, 16 or 17, characterized in that the radiator (10) has ribs (13) protruding from the thermoelectric generator (2) in a non-uniform manner with respect to each other.

19. The mask of claim 14, 15, 16 or 17, characterized in that the radiator (10) has ribs (13) protruding from the thermoelectric generator (2) in a non-uniform manner along their length.

20. The mask of claim 1, 2, 3, 4, 5, 6, 7, 8, 9, 10, 11, 12, 13, 14, 15, 16, 17, 18 or 19, characterized in that the mask body (1) has, at the edges, at least one gasket (14), preferably with a porous structure.

21. The mask of claim 20, characterized in that the one or more gaskets (14) have grooves for a substance that alleviates skin inflammation, preferably containing aloe extract.

22. The mask of claim 20 or 21, characterized in that one or more gaskets (14) have, on their surface, a substance that alleviates skin inflammation, preferably containing aloe extract.

23. The mask of claim 20, 21, or 22, characterized in that one or more gaskets (14) have, inside their pores, a substance that alleviates skin inflammation, preferably containing aloe extract.

24. The mask of claim 1, 2, 3, 4, 5, 6, 7, 8, 9, 10, 11, 12, 13, 14, 15, 16, 17, 18, 19, 20, 21, 22 or 23, characterized by in that the thermoelectric generator (2) has whiskers (15) on its inner side, partially or completely extending laterally beyond the edges of the thermoelectric generator (2).

25. The mask of claim 1, 2, 3, 4, 5, 6, 7, 8, 9, 10, 11, 12, 13, 14, 15, 16, 17, 18, 19, 20, 21, 22, 23 or 24, characterized by having an illumination element (16), preferably in the form of an electroluminescent diode.
